(19) United States
(12) Patent Application Publication
(10) Pub. No.: US 2024/0033827 A1
(43) Pub. Date: Feb. 1, 2024

(54) METHOD FOR GENERATIVE MANUFACTURING OF COMPONENTS

(71) Applicant: RHEINISCH-WESTFÄLISCHE TECHNISCHE HOCHSCHULE (RWTH) AACHEN, Aachen (DE)

(72) Inventors: Lukas OSTER, Aachen (DE); Samuel MANN, Aachen (DE); Uwe REISGEN, Eschweiler (DE); Rahul SHARMA, Aachen (DE)

(21) Appl. No.: 18/265,391

(22) PCT Filed: Dec. 14, 2021
(86) PCT No.: PCT/DE2021/101000

§ 371 Date: Jun. 5, 2023

(30) Foreign Application Priority Data
Jan. 27, 2021 (DE) 10 2021 101 846.3

(51) Int. Cl. B22F 10/50; B22F 12/20; B22F 12/90

(52) U.S. Cl. CPC B22F 10/50; B22F 12/20; B22F 12/90; B33Y 10/00

(57) ABSTRACT

A method for the generative manufacturing of components, the method comprising melting of a metallic filler material along a trajectory on a substrate, wherein a component is built up layer by layer on the substrate, wherein the component is spatially selectively tempered by a directed fluid jet during the build-up of a layer or subsequently to the build-up of a layer and prior to the build-up of a further layer, depending on at least one spatially resolved temperature measured value detected at a specific location on the layer by a sensor or a cooling curve derived from a plurality of these temperature measured values successively detected at the location, wherein the component is spatially selectively exposed to an aerosol jet comprising a material constituent which undergoes an endothermic phase transition when the aerosol jet hits the component.

### CROSS-REFERENCE TO RELATED APPLICATIONS

This application is a U.S. National Phase Application under 35 U.S.C. 371 of International Application No. PCT/DE2021/101000, filed on Dec. 14, 2021, which claims the benefit of German Patent Application No. 10 2021 101 846.3, filed on Jan. 27, 2021. The entire disclosures of the above applications are incorporated herein by reference.

### BACKGROUND

This section provides background information related to the present disclosure which is not necessarily prior art.

### TECHNICAL FIELD

The invention starts from a method for the generative manufacturing of components, the method comprising melting a metallic filler material along a trajectory on a substrate, whereby a component is built up layer by layer on the substrate. Such a method is known, for example, from WO 2018/228919 A1. Similar methods are also described in DE 10 2017 216 704 A1, DE 10 2014 203 711 A1 and DE 10 2015 108 131 A1.

### DISCUSSION

DE 10 2015 122 889 B3 describes a method and a measuring device for the non-destructive estimation of the tensile strength of a welded material having at least one ferritic microstructure. The measuring device for determining the tensile strength has an energy source for melting a metallic filler material, a temperature measuring unit for measuring a temperature-time curve of the melted filler material and an evaluation unit for determining the transformation start temperature for a ferritic or bainitic microstructure transformation of the filler material and for applying a regression line for determining the tensile strength of the welded filler material.

DE 10 2015 108 131 A1 discloses a further method for additive manufacturing in which the welding process is monitored by means of sensors, whereby the welding parameters of the welding process are to be influenced by means of recorded sensor data in such a way that the heat dissipation from a molten filler material at a processing point is kept constant, whereby the microstructure of the molded part is to be improved and residual stresses are to be reduced with shorter production times.

EP 3 359 320 B1 describes another method for additive manufacturing in which a cooling fluid is provided adjacent to the generation effect site on the surface of the substrate via a nozzle, the fluid supply having a plurality of nozzles arranged annularly around a material supply, the fluid volume flow of each nozzle being individually controllable.

Another additive manufacturing process is known from EP 3 646 967 A1, in which a cooling fluid volume flow, with which a substrate is at least partially impinged, is readjusted in such a way that a heat dissipation of an filler material required to achieve preferred material properties of a built-up component is achieved.

EP 3 581 380 A2 also describes a method for process monitoring in additive manufacturing to improve the predictability of the material properties of a built-up component.

WO 2017/059842 A1 describes a processing module for an apparatus for additive manufacturing, wherein the processing module has a material feed device and a protective gas feed device, which has one or more outflow openings arranged in an annular shape around the material feed device, via which a cooling fluid is applied to a surface of the molded part directly next to the generation effect location.

Wire Arc Additive Manufacturing is a high-performance process for the additive manufacturing of metallic components, which enables the realization of high deposition rates. The high manufacturing speed is accompanied by a high heat input into the component. Depending on the material processed, the high heat input can cause a significant deterioration of the mechanical-technological material properties. For this reason, precise process monitoring is of particular importance to safeguard the component properties. Although known approaches aim at temperature monitoring by means of an infrared camera or a pyrometer, they have insufficient accuracy because only global temperatures of the built-up component are recorded. Infrared cameras are usually used here, which provide temperature information whose quality is not sufficient to make a statement about the mechanical properties.

Therefore, the temperature control of the built-up component in additive manufacturing is an essential factor for increasing economic efficiency by reducing production times. The focus here is on dissipating excess heat from the component. In addition, different temperature gradients form over the workpiece, which lead to inhomogeneous material properties over the component volume. The causes lie in material accumulations, but also in path planning or in varying boundary conditions for heat dissipation, for example as a result of inhomogeneous cooling by cooling media or cooling plates.

### SUMMARY

This section provides a general summary of the disclosure, and is not a comprehensive disclosure of its full scope or all of its features.

It is therefore one aspect of the invention to propose a method for additive manufacturing which, with high application rates and thus short process times, also allows preferred material properties to be maintained, preferably over the entire component volume.

Accordingly, it is provided that the component is spatially selectively tempered by a directed fluid jet, either during the build-up of a layer or subsequently to the build-up of a first layer and prior to the build-up of a further, second layer on the first layer. The tempering is to be performed as a function of either at least one spatially resolved temperature reading acquired at a particular location on the layer by a sensor, or a cooling curve derived from a plurality of temperature readings acquired sequentially at the location. Temperature control may include heating and cooling. The component is exposed to a spatially selective aerosol jet having a material constituent that undergoes an endothermic phase transition when the aerosol jet hits the component.

In particular, the process can be used in the context of arc-based additive manufacturing, for example in application of a wire arc additive manufacturing (WAAM) process. In particular, building up the first layer and/or building up the further layer on the first layer may comprise performing a WAAM process.

The location-selective temperature control can be provided with the aid of at least one movable temperature control nozzle or with the aid of a plurality of temperature control nozzles which are oriented differently with respect to the component to be temperature controlled and which can be selectively controlled. Tempering can, for example, comprise heating of the component if, due to a comparatively high external surface area of the component in relation to the volume of the component, heat dissipation to the ambient air is higher than is desired for cooling to achieve desired material properties. Where and with what intensity the component, in particular the built-up layer, is cooled or heated can be determined on the basis of a wide variety of parameters or using a wide variety of temperature control models. The spatially resolved temperature of the component or the last or currently built-up layer can be determined with the aid of a thermal imaging camera or a pyrometer.

The tempering requirement can also be influenced by suitable path planning of the energy source. Path planning can be used to infer material accumulations. Finally, a stored empirical expert model can be used to determine the tempering requirement. As it is basically known from the prior art, temporal parameters such as the t8/5 time can be used to maintain the material properties. With the aid of the process described above, the material properties of the assembled component can be controlled in a targeted manner and material failure prevented. The use of tempering fluids allows in-situ cooling at a safe distance from the additive mold already during the manufacturing process. The tempering process is therefore more effective and thus more resource-efficient, especially with regard to the consumed tempering medium.

The tempering process can include the atomization of a tempering medium, for example to generate an aerosol. The atomized tempering medium may be subjected to focusing to further specify the location on the component or built-up layer that is impacted by the tempering medium. For example, the tempering medium can be passed through a nozzle that has a groove extending spirally around its inner circumference in the direction of passage of the nozzle. When the tempering medium is passed through the nozzle, the tempering medium experiences a twist around its propagation direction only at its outer circumference, which counteracts a divergence of the fluid jet or leads to a compaction of the fluid jet.

The at least one spatially resolved measured temperature value and/or the cooling curve can be recorded simultaneously or successively at different locations of the layer and a temperature distribution and/or a temperature gradient along a surface of the layer can be determined from the recorded measured temperature values or from the cooling curves. With the aid of the spatially resolved determination of cooling curves of the built-up component, a reliable local prediction of the tensile strength can also be achieved in the additive processing of low-alloy steels.

In the case of location-selective tempering, a volume flow rate of the fluid jet can be set as a function of the spatially resolved measured temperature value, or of the cooling curve, or of a temperature gradient derived therefrom along a surface of the layer.

During location-selective temperature control, further temperature values and/or a cooling curve can be recorded continuously or periodically at the temperature-controlled location of the layer. A cooling or heating capacity of the fluid jet in relation to the layer can be readjusted in-situ by varying a volume flow of the fluid jet depending on the further measured temperature values and/or the cooling curve.

The at least one measured temperature value and/or the cooling curve can be determined simultaneously at several different locations on the layer. From a difference of the measured temperature values of adjacent locations on the layer and/or from the difference of the cooling curve of adjacent locations on the layer, a heat flow within the layer between the locations can be concluded. In the case of location-selective temperature control, a cooling or heating power of the fluid jet can also be selected according to minimizing the heat flow within the layer or the component.

The tempering may comprise spatially selectively applying a fluid jet to the component. In this context, the tempering may preferably further comprise atomizing a liquid or solid tempering medium, preferably forming an aerosol containing the tempering medium. For example, the component or the last built-up layer can be cooled or heated by aerosols and/or a liquid, gas or solid jet, respectively. This may involve an endothermic phase transition of suspended particles in the fluid, for example in aerosol particles of the aerosol, for example from liquid to gas. In addition, heat transfer can occur by conduction of heat from the component into aerosol particles.

The temperature control, i.e. the application of the directed fluid jet to the component or layer, can be performed independently of any movement of the additive mold or the energy source during the build process, which results in an economic advantage. In contrast, global cooling via gases or immersive liquid cooling of the workpiece is provided in the prior art.

Accordingly, tempering may comprise spatially selectively impinging the component with an aerosol, liquid, gas or solid jet comprising a material constituent that undergoes an endothermic phase transition and/or is heated or cooled by thermal conduction when it hits the component during the impingement.

Tempering may comprise aligning at least one tempering medium outlet, preferably a nozzle, of a tempering medium source with a portion of the component to be cooled or heated. For this purpose, the tempering medium source can be moved relative to and spaced from the component as well as independently of an energy source for melting the metallic filler material and/or independently of the sensor.

The tempering may comprise selectively activating one or more of a plurality of tempering medium outlets of a tempering medium source, for which purpose the plurality of tempering medium outlets are statically disposed around the component and facing the component.

A cooling power for cooling the location on the layer at which the measured temperature value is recorded with the sensor in a spatially resolved manner, or a section of the component comprising the location, or a heating power for heating the location or the section of the component can be achieved by varying the tempering medium volume flow which acts on the component. The tempering medium flow rate can be adjusted in such a way that the cooling curve derived from the spatially resolved temperature values approximates a desired cooling curve.

The substrate or component can be moved along the trajectory relative to a fixed energy source for melting the filler material. The kinematic component motion can be used, with the energy source fixed and preferably also a fixed sensor, such as a pyrometer, to obtain a fixed spatial relationship between the trajectory and the location on the layer where the spatially resolved temperature measurement is made.

Accordingly, the substrate or the component can be moved along a complex trajectory under the energy source. This enables the sensor, for example a pyrometer, to record cooling curves with spatial resolution under constant boundary conditions. By linking the movement information of the energy source with the determined cooling curves, a spatially resolved gradient map can be created and from this the mechanical properties of the generated component can be determined with spatial resolution. Thus, the determination of the tensile strength distribution of a produced component over its entire volume during its production, i.e. in-situ, is proposed, for example for the purpose of quality assurance and the estimation of structural properties.

Alternatively, if the energy source is static and the substrate or component is moving relative to the energy source, a spatially resolved gradient map can be generated by linking the movement information of the component with respect to the energy source with the determined cooling curves, and from this the mechanical properties of the component can be derived in a locally resolved manner.

The substrate may further be moved along the trajectory relative to at least one fixed sensor for spatially resolved detection of at least one property, preferably a temperature, of a most recently built layer of the component.

The sensor may be maintained at a fixed relative disposition to the energy source, preferably at a fixed acute angle and/or to the energy source, moving the substrate along the trajectory with respect to the energy source and the sensor while maintaining the fixed relative disposition between the energy source and the sensor.

The method may further comprise the point-by-point detection of at least one measured value, such as the temperature measured value, at at least one measuring point on the most recently built-up layer with the sensor. Preferably, the same relative arrangement between the respective measuring point on the layer and a respective melt bath of the filler material for building up the layer is maintained for several pairs of measured value measuring points. For example, the sensor can be fixed in relation to an energy source and preferably have the same feed along the trajectory as the energy source.

A plurality of the measured values can be recorded at a corresponding plurality of measuring points on the built-up component, with preferably at least one measured value being recorded for each measuring point. A spatially resolved measured value curve along the trajectory can be generated from the plurality of measured values, for example by means of a regression analysis.

The sensor can be used to measure the temperature of the built-up component at at least one measuring point on the built-up component. A temperature gradient along the trajectory can be determined from the temperature at the measuring point, a distance of the measuring point from a melt pool along the trajectory, and a feed rate of the energy source along the trajectory.

The sensor used for determining the measured value can be a sensor for directional, non-contact temperature measurement, for example a pyrometer, with which a spatially resolved cooling curve of the last built-up layer of the component is determined.

The method may further comprise manipulating the trajectory and/or at least one process parameter for melting the filler material and/or for building up the component layer by layer. The manipulating may be arranged to approximate or further approximate the determined cooling curve to a preferred cooling curve to adjust a preferred material property.

A spatially resolved cooling curve can be determined at a plurality of measuring points on the last layer built up and/or on a plurality of layers built up one after the other. A spatially resolved cooling gradient map of the layer or component can be determined from the determined spatially resolved cooling curves and at least one mechanical property of the last built-up layer or component can be determined locally resolved.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Further details of the invention are explained with reference to the figures below. Thereby shows:

FIG. 1 a schematic representation of a process according to the invention according to a first embodiment;

FIG. 2 a schematic representation of a process according to the invention according to a second embodiment;

FIG. 3 a detailed view of an exemplary device for carrying out a process according to the invention;

FIG. 4 a measuring point grid of a sensor for the location-selective acquisition of temperature values;

FIG. 5 a cooling gradient map derived from temperature measurements taken along a grid according to FIG. 4; and

FIG. 6 a resulting deformation of a generatively manufactured component derived on the basis of the cooling gradient map according to FIG. 5.

### DETAILED DESCRIPTION

Example embodiments will now be described more fully with reference to the accompanying drawings.

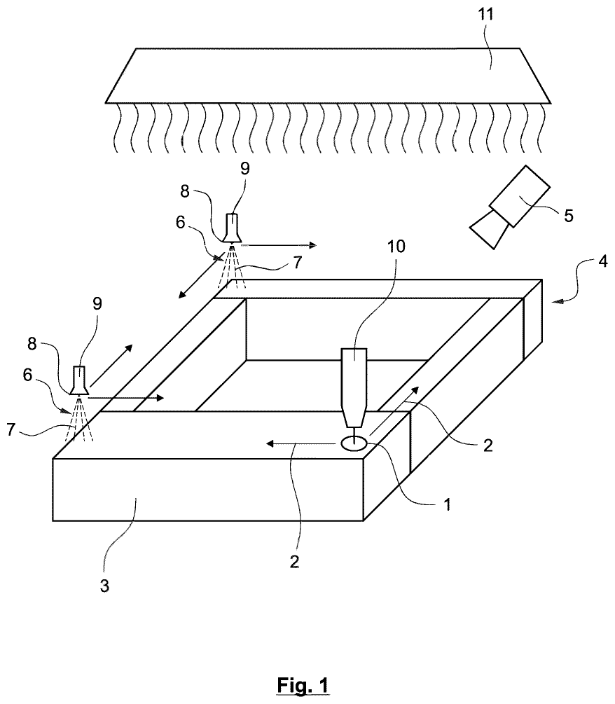

FIG. 1 shows a schematic representation of a first embodiment of a process for the generative manufacturing of components according to the invention. An energy source 10 is used to generate a melt pool of a filler material 1 locally on a substrate 3 or on a material layer previously applied to the substrate. The energy source 10 and a filler material supply (not shown) are moved along the trajectory 2 to build up the component layer by layer, for example, according to a previously generated CAD design. Alternatively, the energy source 10 and the filler material supply (not shown) can also be arranged statically and under a defined alignment to each other and the component, thus the substrate 3, can be moved relative to the energy source 10 and the filler material supply. In this case, the substrate 3 or the component 4 can be moved along a complex trajectory 2 under the energy source 10. This makes it possible to use a sensor 5, for example a pyrometer, to record spatially resolved cooling curves under constant boundary conditions.

The entire buildup process is detected by a sensor 5, which is designed as a pyrometer or a thermal imaging camera. The pyrometer or the thermal imaging camera is set up to detect the temperature of the component 4, or at least of the last layer of the component 4 to be built up, in a spatially resolved manner in order to enable spatially selective temperature control of the layer or the component 3 as a function of the detected temperature distribution or spatially selectively detected cooling curves. The temperature control, in particular the cooling of the component or the most recently applied layer, can be set up to approximate the actual cooling curve of the layer or the component 3 detected with the aid of the sensor 5 to a preferred cooling curve with respect to the desired material properties. Alternatively, or additionally, the aim can be to approximate the cooling curves over the entire component so that homogeneous material properties are achieved over the entire component body. For example, depending on the local surface-to-volume ratio, the natural cooling by free convection and heat radiation to the ambient air can vary over the volume of the component, so that the cooling curves can be approximated over the entire component body by targeted temperature control.

At least one tempering medium source 9 is provided for controlling the temperature of the layer or component 3, which can, for example, apply a directed fluid jet 6 via a tempering medium outlet 8, such as a nozzle, to a point on the component 3 that requires temperature control. The directed fluid jet 6 can have, for example, an aerosol as the tempering medium 7. Alternative temperature control media may comprise oils or oil emulsions for adjusting the boiling point of the tempering medium. In addition, the oils or oil emulsions may provide corrosion protection for the component 4. To stabilize the arc, the tempering medium may have, for example, a potassium solution, so that the tempering medium can still be used to stabilize the arc in addition to its tempering property. By using fluxes as tempering medium, oxides on the layer can be removed or the penetration can be changed, respectively. In addition, the use of other chemical additives is conceivable, which lead to a change in the alloy composition during over-welding.

When using an aerosol for temperature control, in particular for cooling the component, the aim can be to increase the evaporation temperature so that the liquid contained in the aerosol comes closer to the process zone, thus achieving more effective heat transfer from the component to the aerosol via the enthalpy of evaporation. Here, for example, oil-water emulsions can be used as liquids of the aerosol. Due to their heat capacity and thermal conductivity, the use of gases can also be advantageous if temperature control, in particular cooling, is to be carried out in the immediate vicinity of the molten bath. The use of inert gases in particular has proven to be expedient for avoiding pores. Tempering medium which evaporates during the tempering process can be collected with the aid of a tempering medium recovery unit 11 and, after condensation, recirculated for reuse in the tempering medium sources 9.

In particular, it may be provided that the substrate 3 is moved relative to the energy source 10 along the trajectory 2, while the energy source 10 is stationary. In this way, a fixed relationship between the welding trajectory 2 and a temperature measuring point of the sensor 5 on the component 3 can be achieved. Through this, cooling curves can be measured under constant boundary conditions by means of the sensor 5, which can be a pyrometer, for example. A machine learning algorithm based on a pre-trained neural network can be used to determine a cooling curve for a materially relevant area of the component 3 from the acquired information. By linking the motion information of the component under the energy source 10 with the determined cooling curves, a spatially resolved gradient map can be generated and from this the mechanical properties of the component can be derived in a locally resolved manner.

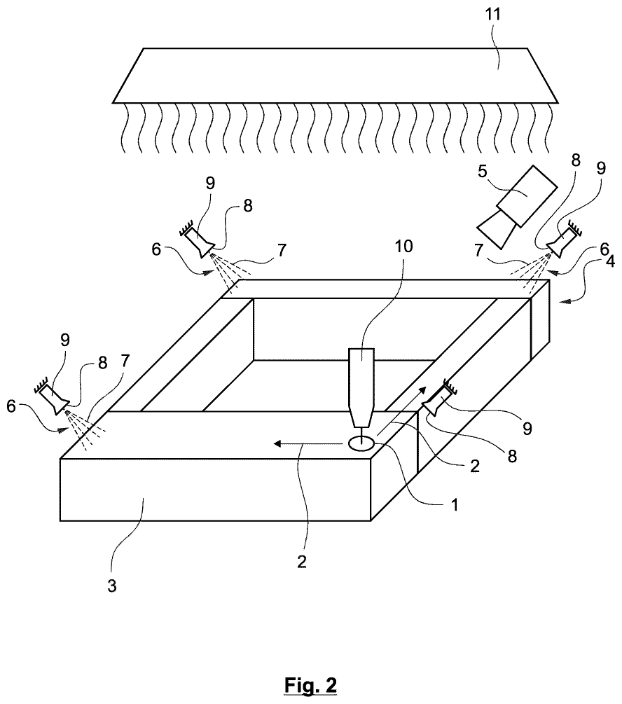

FIG. 2 shows a further embodiment of a process according to the invention in which, in deviation from the embodiment according to FIG. 1, the tempering medium sources 9 are arranged statically and controlled according to a determined temperature control requirement in order to temperature control the layer selectively with a directed fluid jet 6. For this purpose, it can be provided on the one hand that the tempering medium sources 9 are selectively controlled and on the other hand that the component 3 is moved, for example by an articulated robot, with respect to at least one of the tempering medium sources 9 in such a way that the outlet 8 of the tempering medium source 9 faces exactly a point of the last layer or component 3 that requires temperature control, so that a highly precise, location-selective application of the directed fluid jet 6 to the component or layer is possible.

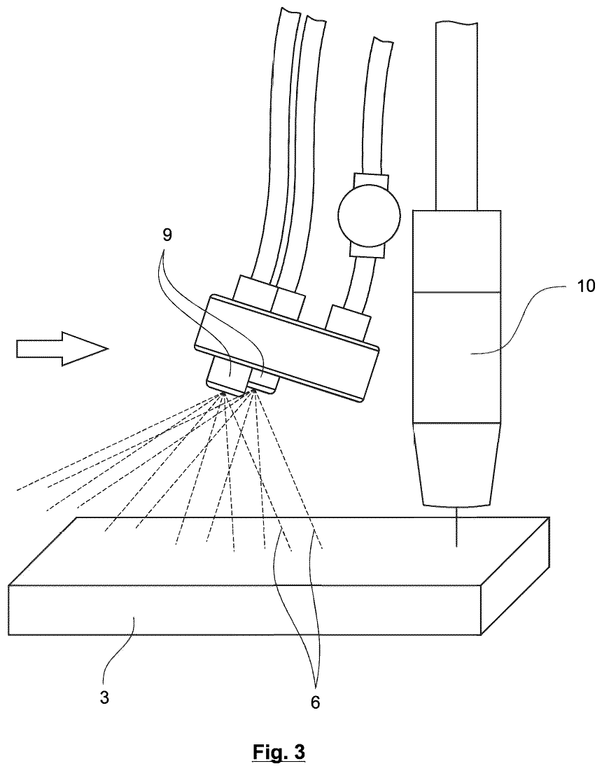

FIG. 3 shows a detailed view of an exemplary setup for carrying out the process according to the invention. A tempering medium source 9 is arranged in the welding direction of an energy source 10, for example an arc or plasma arc welding torch. In this case, the tempering medium source 9 faces the substrate 3 at an acute angle to the energy source 10 and is aligned opposite to the welding direction. The energy source 10 and the tempering medium source 9 are arranged at a rigid relationship to each other, in particular at a fixed angle and a fixed distance from each other. For example, the energy source 10 and the tempering medium source 9 can be positioned in a fixed arrangement relative to one another on an end effector of an articulated arm robot. Due to the fixed arrangement of the tempering medium source 9 in relation to the energy source 10, the last applied layer or component is exposed to the tempering medium emerging from the tempering medium source 9 at a given feed rate of the arrangement of energy source 10 and tempering medium source 9 in the welding direction at a constant time interval, so that the influence of the temperature of the melt or the solidifying material can be reliably adjusted by the exposure of the tempering medium source 9. This makes it possible to precisely influence the cooling curve of the applied material and thus the material properties of the material.

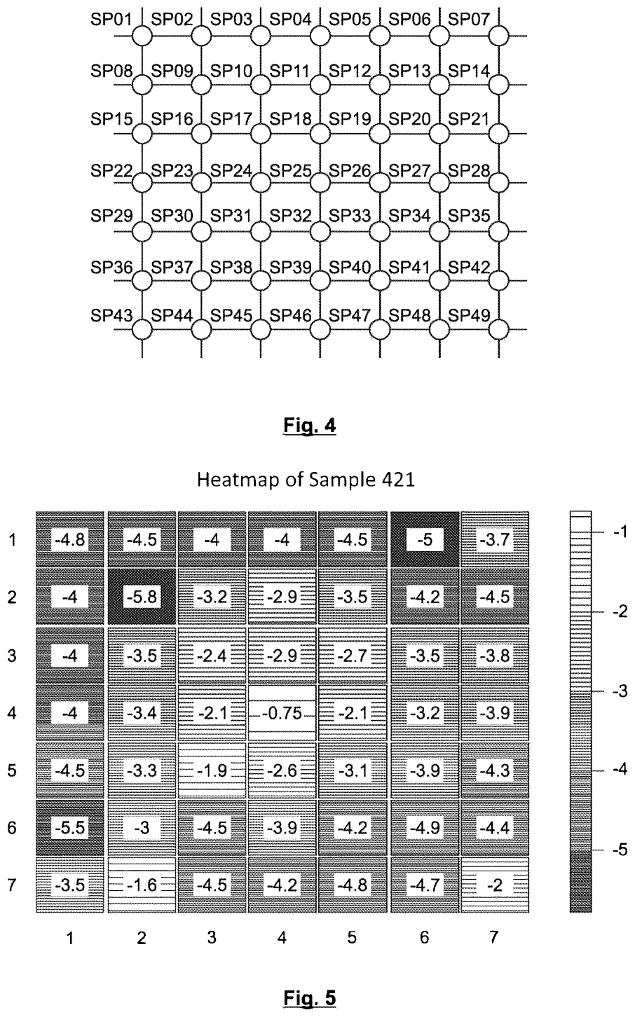

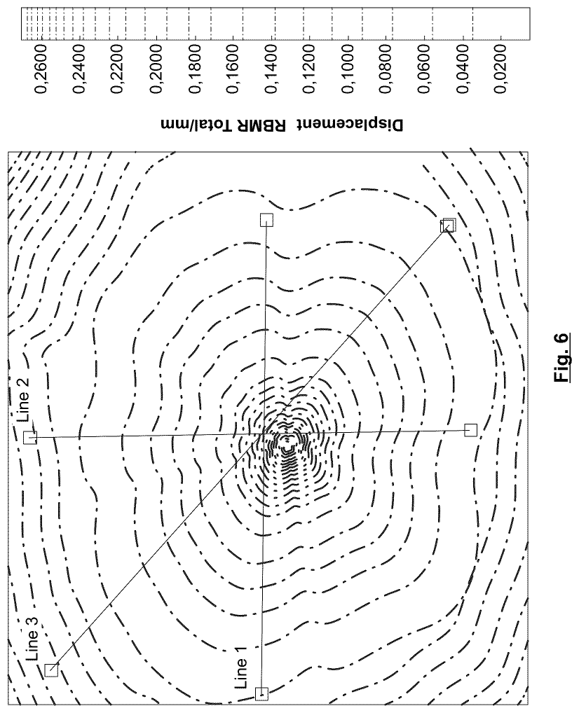

FIGS. 4 to 6 illustrate, on the one hand, a measuring grid which can, for example, be that of a pyrometer, which can be used as a sensor for spatially resolved temperature measurement on the surface of the applied component, in particular of a layer applied last. With the aid of the sensor, a temperature reading can be recorded continuously or periodically along the grid points, so that at a given location on the component or the last applied layer, a cooling curve can be determined from a plurality of temperature values recorded one after the other at a respective grid point, from which conclusions can be drawn about a material property of the built-up material. In addition to tensile strength, stresses within the material can also be derived from a cooling gradient map determined from the recorded cooling curves as shown in FIG. 5. For example, in the case of large-volume components, due to the greater cooling in the surface area of the component compared to areas further inside the component, mechanical stress in the component can be determined on the basis of the resulting deviations in the cooling gradient map. Likewise, tensile strength values distributed over the volume of the component can be determined from the cooling gradient map.

The features of the invention disclosed in the foregoing description, in the drawings as well as in the claims may be essential to the realization of the invention both individually and in any combination.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-18. (canceled)

19. A method for generative manufacturing of components, the method comprising melting of a metallic filler material along a trajectory on a substrate, wherein a component is built up layer by layer on the substrate, wherein the component is spatially selectively tempered by a directed fluid jet during the build-up of a layer or subsequently to the build-up of a layer and prior to the build-up of a further layer, depending on at least one spatially resolved temperature measured value detected at a specific location on the layer by a sensor or a cooling curve derived from a plurality of these temperature measured values successively detected at the location, wherein the component is spatially selectively exposed to an aerosol jet having a material constituent which undergoes an endothermic phase transition when the aerosol jet hits the component.

20. The method according to claim 19, in which the at least one spatially resolved detected temperature measurement value or the cooling curve is detected simultaneously or successively at different locations of the layer and a temperature distribution and/or a temperature gradient along a surface of the layer is determined from the detected temperature measurement values or from the cooling curves.

21. The method according to claim 19, in which, during the spatially selective tempering, a volume flow of the fluid jet is set along a surface of the layer as a function of the spatially resolved measured temperature value, or the cooling curve, or a temperature gradient derived therefrom.

22. The method according to claim 19, in which further temperature measured values and/or a cooling curve are continuously or periodically detected at the tempered location of the layer during the spatially selective tempering, wherein a cooling or heating power of the fluid jet with respect to the layer is readjusted in situ by varying a volume flow of the fluid jet as a function of the further temperature measured values and/or the cooling curve.

23. The method according to claim 19, in which the at least one measured temperature value and/or the cooling curve is determined simultaneously at a plurality of mutually different locations on the layer, a heat flow within the layer between the locations being inferred from a difference in the measured temperature values of adjacent locations on the layer and/or from the difference in the cooling curve of adjacent locations on the layer, and a cooling or heating power of the fluid jet being selected during the spatially selective tempering in such a way that the heat flow is minimized.

24. The method according to claim 19, wherein said tempering comprises spatially selectively impinging said component with a fluid jet, said tempering preferably further comprising spraying a liquid or solid tempering medium, preferably forming an aerosol containing said tempering medium.

25. The method according to claim 19, wherein the tempering comprises aligning at least one tempering medium outlet, preferably a nozzle, of a tempering medium source with a portion of the component to be cooled or heated, for which purpose the tempering medium source is moved relative to and spaced from the component and independently of an energy source for melting the metallic filler material and/or from the sensor.

26. The method according to claim 19, wherein the tempering comprises selectively activating one or more of a plurality of tempering medium outlets of a tempering medium source, for which purpose the plurality of tempering medium outlets are statically arranged around the component and facing the component.

27. The method according to claim 19, in which a cooling power for cooling the location or a section of the component comprising the location or a heating power for heating the location or the section of the component is set by varying the tempering medium volume flow, which acts on the component, in such a way that the cooling curve derived from the location-resolved temperature values is approximated to a desired cooling curve.

28. The method according to claim 19, wherein the substrate is moved along the trajectory relative to a fixed energy source for melting the filler material.

29. The method according to claim 28, wherein the substrate is further moved relative to at least one fixed sensor for the spatially resolved detection of at least one property, preferably a temperature, of a last built-up layer of the component along the trajectory.

30. The method according to claim 19, wherein the sensor is maintained at a fixed relative disposition to the energy source, preferably at a fixed acute angle and/or distance to the energy source, wherein the substrate is moved along the trajectory with respect to the energy source and the sensor while maintaining the fixed relative disposition between the energy source and the sensor.

31. The method according to claim 19, comprising the point-by-point detection of at least one measured value, such as the measured temperature value, at at least one measuring point on the most recently built-up layer with the sensor, wherein preferably for several pairs of measured value measuring points the same relative arrangement is maintained between the respective measuring point on the layer and a respective melt bath of the filler material for the build-up of the layer.

32. The method according to claim 19, in which a plurality of the measured values are recorded at a corresponding plurality of measuring points on the built-up component, and wherein a spatially resolved measured value curve along the trajectory is generated from the plurality of measured values, for example by means of a regression analysis.

33. The method according to claim 19, in which the sensor is used to detect the temperature of the built-up component at at least one measuring point on the built-up component, a temperature gradient along the trajectory being determined from the temperature at the measuring point, a distance of the measuring point from a melt pool along the trajectory, and a feed rate of the energy source along the trajectory.

34. The method according to claim 19, in which, in the determining, as the sensor, a sensor for directional, non-contact temperature measurement, for example a pyrometer, is used, with which a spatially resolved cooling curve of the last built-up layer of the component is determined.

35. The method according to claim 34, comprising manipulating the trajectory and/or at least one process parameter for melting the filler material and/or for building up the component layer by layer, which is aimed at approximating or further approximating the determined cooling curve to a preferred cooling curve.

36. The method according to claim 34, in which a spatially resolved cooling curve is determined at a plurality of measuring points on the layer built up last and/or on a plurality of layers built up one after the other in succession, wherein from the spatially resolved cooling curves determined therein, a spatially resolved cooling gradient map of the layer or of the component and, in locally resolved form, at least one mechanical property of the layer built up last or of the component is determined.
